(19) United States
(12) Patent Application Publication
(10) Pub. No.: US 2016/0349783 A1
(43) Pub. Date: Dec. 1, 2016

(54) Bandgap Voltage Reference

(71) Applicant: Dialog Semiconductor B.V., 's-Hertogenbosch (NL)

(72) Inventor: Marinus Wilhelmus Kruiskamp, 's-Hertogenbosch (NL)

(21) Appl. No.: 14/957,756

(22) Filed: Dec. 3, 2015

(30) Foreign Application Priority Data
Jun. 1, 2015 (DE) 102015210018.9

(51) Int. Cl. G05F 3/02

(52) U.S. Cl. CPC G05F 3/02

(57) ABSTRACT

A bandgap circuit for providing a bandgap voltage reference comprises a first capacitor and a second capacitor. An inverting amplifier, which is associated with an offset voltage has an input terminal connected to a first terminal of the first capacitor and a first terminal of the second capacitor, and an output terminal connected to an output terminal of the bandgap circuit. A temperature dependent component has a temperature dependent terminal wherein a voltage of the temperature dependent terminal has a linear relationship with a temperature based on a temperature constant, wherein the temperature constant depends on an amount of current, wherein a second terminal of the second capacitor is connected to the temperature dependent terminal. A first switch selectively connects a second terminal of the first capacitor with the temperature dependent terminal. A second switch selectively connects the output terminal of the inverting amplifier with the input terminal.

### TECHNICAL FIELD

The invention relates to a bandgap voltage reference circuit.

### BACKGROUND

Bandgap voltage reference circuits are used to generate a voltage that is independent of temperature. Most bandgap voltage reference circuits use resistors. The resistor based circuits work well, but when the bandgap needs to be very low power (in the order of 100 nA), the resistor values required for such a bandgap reference become impractically large. In such a situation it is better to use a switched-capacitor equivalent of the bandgap reference circuit.

U.S. Pat. No. 5,563,504 discloses a switched-capacitor bandgap circuit. A switched capacitor network is used in conjunction with a single PN junction to form a switching bandgap reference voltage circuit. The circuit includes an amplifier having an inverting input, a non-inverting input, and an output. A first capacitor having a first capacitance coupled between the amplifier inverting input and a first common voltage source. A second capacitor having a second capacitance coupled between the amplifier inverting input and the amplifier output. A transistor having a base, a collector, and an emitter, the base and collector being coupled to the first common voltage source, and the emitter being coupled to the amplifier non-inverting input. Two current sources are coupled to the transistor to bias the transistor to a one level during a pre-charge mode and a second, higher level during a reference voltage mode. A switch is connected in parallel with the second capacitor. The switch is opened during the pre-charge mode and closed during the reference voltage mode wherein a bandgap reference voltage is produced at the amplifier output during the reference voltage mode.

### SUMMARY

In a first aspect, the invention provides an improved switched-capacitor bandgap circuit. The circuit comprises

a first capacitor and a second capacitor;

an inverting amplifier associated with an offset voltage, the inverting amplifier having an input terminal connected to a first terminal of the first capacitor and a first terminal of the second capacitor, and an output terminal connected to an output terminal of the bandgap circuit;

a temperature dependent component with a temperature dependent terminal wherein a voltage of the temperature dependent terminal has a linear relationship with a temperature based on a temperature constant, wherein the temperature constant depends on an amount of current, wherein a second terminal of the second capacitor is connected to the temperature dependent terminal;

a first switch to selectively connect a second terminal of the first capacitor with the temperature dependent terminal;

a second switch to selectively connect the output terminal of the inverting amplifier with the input terminal of the inverting amplifier; and

a third switch to selectively connect the second terminal of the first capacitor with the output terminal of the inverting amplifier.

This circuit is less complex compared to a prior art circuit. Also, this circuit can be implemented with a simpler inverting amplifier. A less complex circuit can be made to be smaller and/or consuming less power.

For example, the inverting amplifier can be a single-ended amplifier, such as a common source amplifier or an inverter. This is a relatively simple kind of amplifier.

The inverting amplifier may comprise a differential amplifier with a differential input comprising an inverting input terminal and a non-inverting input terminal, wherein the non-inverting input terminal is connected to a constant voltage source and the inverting input terminal is the input terminal of the inverting amplifier that is connected to the first terminal of the first capacitor and the first terminal of the second capacitor. This provides, for example, the possibility to generate the offset voltage independently of the amplifier.

During a first phase of operation, the first switch may be configured to be closed, the second switch may be configured to be closed, and the third switch may be configured to be open. This helps to pre-charge the capacitors with a voltage.

During a second phase of operation following the first phase of operation, the first switch may be configured to be open, the second switch may be configured to be open, and the third switch may be configured to be closed. This helps to provide the temperature-independent bandgap voltage.

The second switch may be configured to be opened before the first switch is opened near the end of the first phase. The second switch should preferably be opened at the same time or before the first switch is opened. To safeguard this, the second switch can be configured to be opened a predetermined time interval before the first switch is opened, near the end of the first phase. This makes the circuit less sensitive to timing variations due to noise, temperature, or random process variations.

The first phase and the second phase may be non-overlapping in time, and the third switch may be configured to be closed near the beginning of the second phase of operation, after the first switch and the second switch have been opened. This makes the circuit more stable.

The circuit may comprise a current source configured to apply a constant current to the temperature dependent component, wherein the current source is configured to apply a first constant current to the temperature dependent component during the first phase, and apply a second constant current to the temperature dependent component during the second phase, wherein the first constant current is different from the second constant current. This helps to generate the temperature independent voltage.

The first constant current may be greater than the second constant current. This provides for a circuit with reduced size capacitor.

A ratio of a capacitance of the first capacitor to a capacitance of the second capacitor may be based on a ratio of a first temperature constant and a second temperature constant, wherein the first temperature constant defines a relation between temperature and a voltage of the temperature dependent terminal associated with a particular current, and wherein the second temperature constant defines a relation between temperature and a difference between a voltage of the temperature dependent terminal associated with the first constant current and a voltage of the temperature dependent terminal associated with the second constant current. This way, the circuit may be fine-tuned to generate the temperature independent voltage.

The temperature dependent component comprises a bipolar transistor or a diode. These are efficient examples of temperature dependent components.

According to another aspect of the invention, a method of generating a bandgap reference voltage is provided. The method comprises

in a first phase of operation, connecting a second terminal of a first capacitor with a temperature dependent terminal of a temperature dependent component, connecting an output terminal of an inverting amplifier with an input terminal of the inverting amplifier, and disconnecting a second terminal of a first capacitor with the output terminal of the inverting amplifier, and applying a first current to the temperature dependent component; and

in a second phase of operation, disconnecting the second terminal of the first capacitor from the temperature dependent terminal of the temperature dependent component, disconnecting the output terminal of the inverting amplifier from the input terminal of the inverting amplifier, and connecting the second terminal of the first capacitor with the output terminal of the inverting amplifier, and applying a second current, which is different from the first current, to the temperature dependent component.

The person skilled in the art will understand that the features described above may be combined in any way deemed useful. Moreover, modifications and variations described in respect of the system may likewise be applied to the method and to the computer program product, and modifications and variations described in respect of the method may likewise be applied to the system and to the computer program product.

### BRIEF DESCRIPTION OF THE DRAWINGS

In the following, aspects of the invention will be elucidated by means of examples, with reference to the drawings. The drawings are diagrammatic and may not be drawn to scale. Similar items are indicated by the same reference numerals throughout the figures.

FIG. 1 shows a circuit diagram of a temperature dependent component.

FIG. 2 shows a characteristic of the temperature dependent component.

FIG. 3 shows a circuit diagram of a bandgap voltage reference circuit.

FIG. 3a shows an example of an inverting amplifier.

FIG. 4 shows a control switch diagram for a bandgap voltage reference circuit.

FIG. 5 shows another circuit diagram of a bandgap voltage reference circuit.

FIG. 6 shows a circuit diagram comprising a bandgap core stage and a sample-and-hold stage.

FIG. 7 shows a control switch diagram for the circuit of FIG. 6.

### DESCRIPTION

FIG. 1 illustrates a circuit with a current source 101 connected to a bipolar transistor 102. The current source 101 is connected to the emitter 103 of the bipolar transistor 102. The base 104 and the collector 105 of the bipolar transistor 102 are connected to ground. The current source 101 can generate two different levels of current, I₁ or I₁+I₂. Such a circuit may be used to build a bandgap voltage reference. Alternatively, the bipolar transistor 102 may be replaced by a diode. Further alternatives, such as alternative semiconductor components having similar characteristics, are also possible.

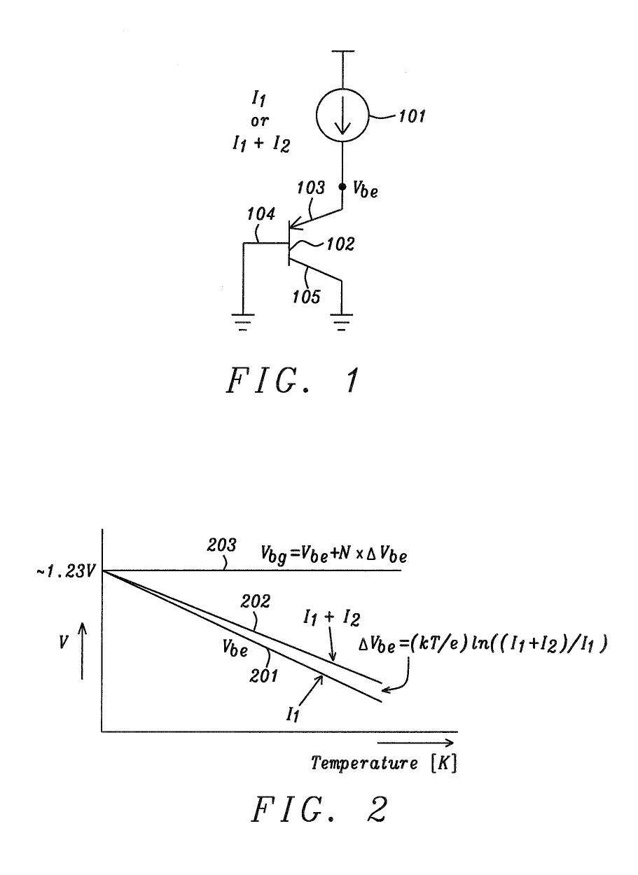

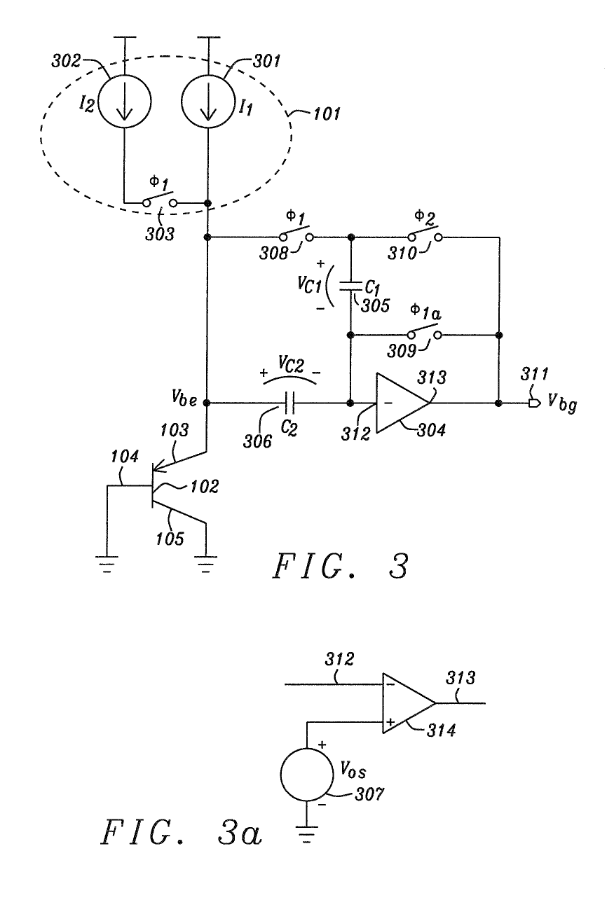

FIG. 2 shows a graph illustrating the principle underlying a bandgap voltage reference. The horizontal axis represents temperature in Kelvin, whereas the vertical axis represents voltage in Volt. Line 201 illustrates the base-emitter voltage V_{be} at the emitter 103 of the bipolar transistor 102 when the current source 101 generates a current of I₁. Line 202 illustrates the same, for the case that the current source 101 generates a current of I₁+I₂. Herein, and I₂ are predetermined positive current values. The difference between the two base-emitter voltages is illustrated as ΔV_{be}. The base-emitter voltage of a bipolar transistor (or of the two terminals of a diode) has a negative temperature constant, whereas the difference between the base-emitter voltage of a bipolar transistor with two different currents has a positive temperature constant. Herein, the temperature constant represents the linear dependence between the voltage (or voltage difference) and the temperature (in Kelvin). Adding the voltage base-emitter voltage and the difference voltage while applying properly selected weight N results in an (almost) temperature independent voltage V_{bg} of about 1.23 V. This is illustrated as line 203 in the figure.

FIG. 3 shows an example diagram of a circuit that can generate such a temperature independent voltage V_{bg}. Two current sources 301 and 302 can generate currents I₁ and I₂, respectively. The two current sources 301 and 302 are arranged in parallel, so that the current provided to the temperature dependent component is the sum of the two currents, I₁ +I₂, wherein I₂ can be selectively switched on and off by switch 303. Other examples of how to create a circuit 101 that can alternately provide two different current levels will be apparent to the skilled person in view of the present disclosure. The bipolar transistor 102 has been described hereinabove with reference to FIGS. 1 and 2. The bipolar transistor 102 is only an example of a temperature dependent component. Emitter 103 is referred to in this disclosure as a temperature dependent terminal, because a voltage V_{be} of the temperature dependent terminal depends on a temperature according to a temperature constant. The temperature constant depends on an amount of current applied to the temperature dependent component 102.

The circuit of FIG. 3 further comprises a first capacitor 305 with capacitance C1 and a second capacitor 306 with capacitance C2, an inverting amplifier 304, and switches 308, 309, and 310, and an output terminal 311.

The inverting amplifier 304 is associated with an offset voltage Vₒₛ, to provide a negative feedback at its output terminal 313 when the voltage at an input terminal 312 of the inverting amplifier differs from the offset voltage Vₒₛ.

FIG. 3a shows an implementation example of the inverting amplifier 304. In FIG. 3a, the inverting amplifier 304 is implemented by means of a differential amplifier 314, wherein the positive input terminal of the differential amplifier 314 is connected to a source 307 providing a constant offset voltage Vₒₛ, and the negative input terminal 312 acts as the input terminal of the inverting amplifier 304. Other implementations of the inverting amplifier 304 are also possible.

The input terminal 312 is connected to a first terminal (e.g. a negative terminal, indicated by −) of the first capacitor 305 and a first terminal (e.g. a negative terminal, indicated by −) of the second capacitor 306. The output terminal 313 of the inverting amplifier 304 is connected to output terminal 311 of the circuit.

The first switch 308 selectively connects second terminal (e.g. a positive terminal, indicated by +) of the first capacitor 305 with the temperature dependent terminal 103. The second switch 309 selectively connects the output terminal 313 of the inverting amplifier 304 with the input terminal 312 of the inverting amplifier 304. The third switch 310 selectively connects the second terminal (e.g. a positive terminal, indicated by +) of the first capacitor 305 with the output terminal 313 of the inverting amplifier 304.

During operation, the state of the switches is controlled according to a predetermined scheme that involves roughly two phases. During the first phase of operation, the first switch 308 is configured to be closed, the second switch 309 is configured to be closed, and the third switch 310 is configured to be open. The switch 309 over the amplifier 304 shorts the output and the input of the amplifier 304: the input of the amplifier will be equal to the offset voltage Vₒₛ. The current through the bipolar transistor 102 is equal to I1+I2, as the switch 303 is also closed. The base-emitter voltage V_{be} at the emitter 103 of the bipolar transistor 102 is determined by the applied current I1+I2 and the temperature; it is denoted by V_{be}(I₁+I₂). Since the second (positive) terminals of the capacitors 305 and 306 are shorted by switch 308, the potential difference over both capacitors is the same. This potential difference is given by V_{c1} =V_{c2} =V_{be}(I₁+I₂)−Vₒₛ.

In the second phase, the switch 303 is open, so that the current that runs through the bipolar transistor 102 is reduced to I1. The voltage V_{be} at the temperature dependent terminal 103 is therefore also reduced and is denoted as V_{be}(I_{I}). The first switch 308 is opened, the second switch 309 is opened, and the third switch 310 is closed during the second phase.

The voltage at the input terminal 312 of the inverting amplifier 304 remains at Vₒₛ or at least returns to Vₒₛ when all voltages have settled. This is because of the negative feedback provided through the switch 310 and capacitor 305. The potential difference over the second capacitor 306 drops due to the decreased voltage V_{be} at the temperature dependent terminal 103. For example, the voltage drop amounts to ΔV_{be} =(kT/e)1n((I₁+I₂)/I₁). Herein, In denotes the natural logarithmic operator, e denotes the charge of an electron, T denotes the absolute temperature, and k denotes the Bolzmann constant. In this case, the voltage drop depends linearly on the thermodynamic temperature T.

The charge needed to discharge C2 has to come from C1 (because the switch 309 over the amplifier 304 is open). Because the negative terminal of the first capacitor 305 remains at voltage Vₒₛ, the voltage at the positive terminal increases with (C2/C1) ΔV_{be} to become V_{be}(I₁+I₂) +(C2/C1) ΔV_{be}.

The output 311 (V_{bg}) is connected via closed switch 310 to the positive terminal of the first capacitor 305 and thus the voltage at the output terminal 311 is also equal to: V_{bg} V_{be}(I₁+I₂) +(C2/C1) ΔV_{be}.

Since the voltage at the input terminal 312 of the inverse amplifier is Vₒₛ in both the first phase and the second phase, this effectively makes the output voltage V_{bg} independent of the offset voltage Vₒₛ of the amplifier 304.

By properly selecting the capacities C1 and C2, the ratio between these two capacities can be chosen such that the output voltage V_{bg} is almost temperature independent. For a bipolar transistor 102 as the temperature dependent component, the voltage V_{bg} will be approximately 1.23 Volt.

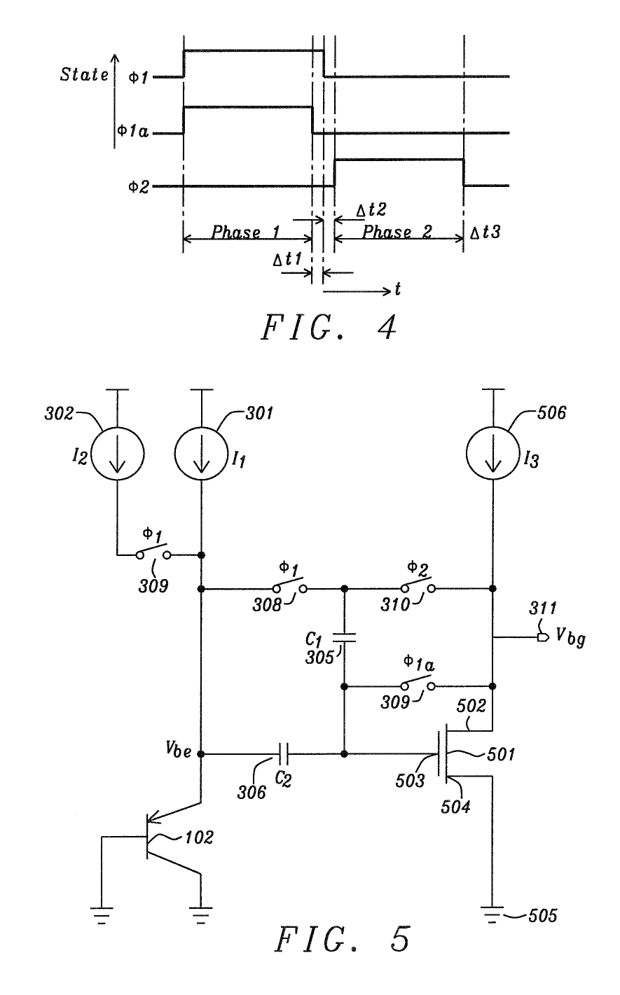

FIG. 4 illustrates the state transitions of the switches in more detail in three graphs. The horizontal axis of each graph represents time. The vertical axis of each graph represents the state; the high state means switch closed, the low state means switch open. Graph Φ₁ represents the state of switches 303 and 308; graph Φ₁ₐ represents the state of switch 309; graph Φ₂ represents the state of switch 310. The first phase and the second phase are non-overlapping. At the end of the first phase, switch 309 is opened shortly before switches 303 and 308, with a time delay Δt₁. After the switches 303, 308, and 309 have been closed, a time delay of Δt₂ is waited before the second phase is started by closing switch 310. At the end of the second phase the switch 310 is opened again. A time delay of Δt₃ is waited before beginning again with the first phase by opening the switches 303, 308, and 309. This pattern can be repeated indefinitely. The frequency with which the phases are repeated depends on the temperature variability, among others.

In another alternative implementation, Φ₁ₐ is equal to Φ₁. This is similar to setting Δt₁ equal to zero. However, a slightly positive Δt₁ helps to make the circuit more robust.

In another alternative implementation, the bipolar transistor 102 is replaced by another temperature dependent component, such as a diode.

The working of the circuit is based on the insight that the input voltage of the amplifier 304 is (almost) constant during the end of phase Φ₁ₐ and the end of phase Φ₂. Assume this voltage is equal to the offset voltage Vₒₛ of the amplifier 304.

FIG. 5 shows a particular implementation of the bandgap circuit of FIG. 3. Most of the circuit is similar to FIG. 3. However, the inverting amplifier 304 of FIG. 3 has been implemented in FIG. 5 by means of a common source amplifier. This common source amplifier comprises transistor 501 and current source 506. Transistor 501 can be an nMOS transistor, for example. For example, current source 506 is connected to the drain 502 of the transistor 501, and the source 504 is connected to ground 505, as illustrated. Current source 506 is configured to produce a current I₃. This causes a voltage between the gate 503 and the source 504 of the transistor 501. This way, the transistor 501 acts as a single-ended inverting amplifier with input terminal at its gate 503 and output terminal at its drain 502. This single-ended inverting amplifier has the characteristics described above in respect of the inverting amplifier 304. It will be understood that the common source amplifier is only one example of implementing the inverting amplifier 304.

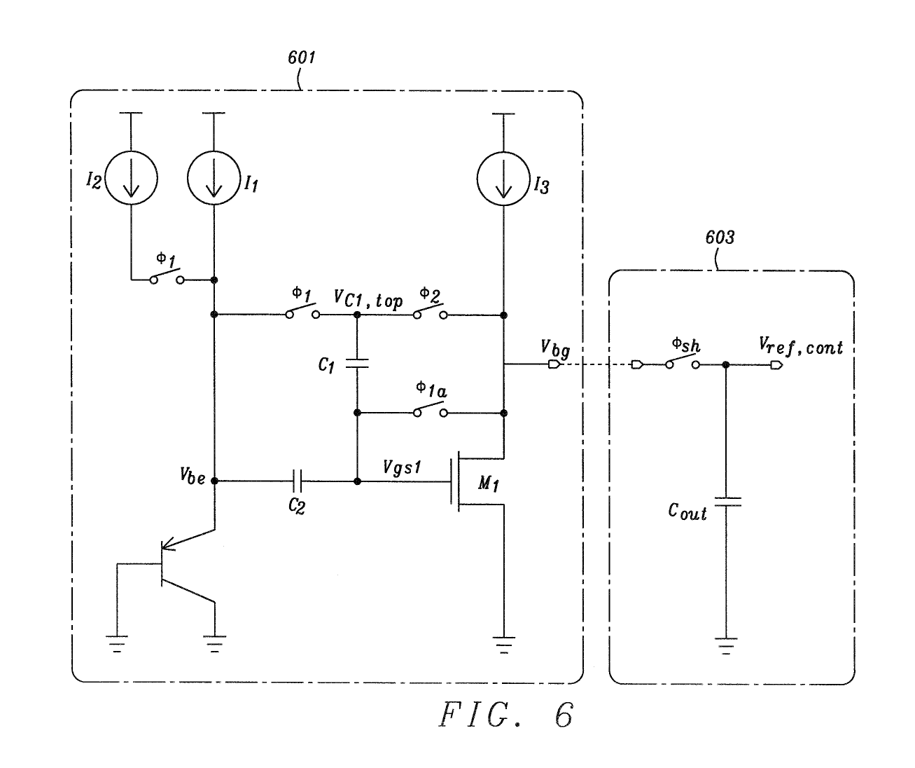

FIG. 6 illustrates how the bandgap circuit can be integrated in a larger circuit. In this example, the output of the 311 of the bandgap circuit 601 is followed by a sample and hold stage 603. In other implementations, the bandgap circuit can be combined with other circuitry, such as a variable gain stage, possibly in combination with the sample and hold stage 603. A variable gain stage can be used to scale the temperature-independent voltage V_{bg} to any voltage needed by the remainder of the circuit. The sample and hold stage 603 can be used to maintain the temperature-independent voltage V_{bg} or V_{ref}, that is generated during the second phase, while the bandgap circuit 601 is in the first phase.

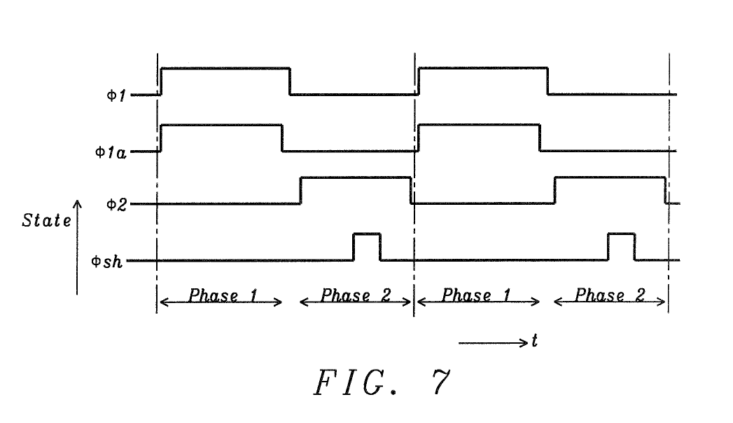

FIG. 7 illustrates how the switches shown in the diagram of FIG. 6 may be switched over time. The switches of the bandgap stage are depicted as graphs Φ₁, Φ₁ₐ, and Φ₂. These graphs are identical to FIG. 4. Graph Φₛₕ shows the state of the switch of the sample-and-hold stage 603.

In a particular implementation example, I₁ and I₃ are about 10 nA, I₂ is about 70 nA, the capacitors about 10 fF for C1 and about 125 fF for C2. The clock frequency may be in the several kHz range. However, these values are only provided by way of example. Many alternative implementations are possible.

The examples and embodiments described herein serve to illustrate rather than limit the invention. The person skilled in the art will be able to design alternative embodiments without departing from the scope of the claims. Reference signs placed in parentheses in the claims shall not be interpreted to limit the scope of the claims. Items described as separate entities in the claims or the description may be implemented as a single hardware or software item combining the features of the items described.

What is claimed is:

1. A bandgap circuit for providing a bandgap voltage reference, the circuit comprising
a first capacitor and a second capacitor;
an inverting amplifier associated with an offset voltage, the inverting amplifier having an input terminal connected to a first terminal of the first capacitor and a first terminal of the second capacitor, and an output terminal connected to an output terminal of the bandgap circuit;
a temperature dependent component with a temperature dependent terminal wherein a voltage of the temperature dependent terminal has a linear relationship with a temperature based on a temperature constant, wherein the temperature constant depends on an amount of current, wherein a second terminal of the second capacitor is connected to the temperature dependent terminal;
a first switch to selectively connect a second terminal of the first capacitor with the temperature dependent terminal;
a second switch to selectively connect the output terminal of the inverting amplifier with the input terminal of the inverting amplifier; and
a third switch to selectively connect the second terminal of the first capacitor with the output terminal of the inverting amplifier.

2. The circuit of claim 1, wherein the inverting amplifier is a single-ended amplifier.

3. The circuit of claim 1, wherein the inverting amplifier is a common source amplifier or an inverter.

4. The circuit of claim 1, wherein the inverting amplifier comprises a differential amplifier with a differential input comprising an inverting input terminal and a non-inverting input terminal, wherein the non-inverting input terminal is connected to a constant voltage source and the inverting input terminal is the input terminal of the inverting amplifier that is connected to the first terminal of the first capacitor and the first terminal of the second capacitor.

5. The circuit of claim 1, wherein during a first phase of operation, the first switch is configured to be closed, the second switch is configured to be closed, and the third switch is configured to be open.

6. The circuit of claim 5, wherein during a second phase of operation following the first phase of operation, the first switch is configured to be open, the second switch is configured to be open, and the third switch is configured to be closed.

7. The circuit of claim 6, wherein the second switch is configured to be opened before the first switch is opened near the end of the first phase.

8. The circuit of claim 6, wherein the first phase and the second phase are non-overlapping in time, and the third switch is configured to be closed near the beginning of the second phase of operation, after the first switch and the second switch have been opened.

9. The circuit of claim 6, comprising a current source configured to apply a constant current to the temperature dependent component, wherein the current source is configured to apply a first constant current to the temperature dependent component during the first phase, and apply a second constant current to the temperature dependent component during the second phase, wherein the first constant current is different from the second constant current.

10. The circuit of claim 9, wherein the first constant current is greater than the second constant current.

11. The circuit of claim 9, wherein a ratio of a capacitance of the first capacitor to a capacitance of the second capacitor is based on a ratio of a first temperature constant and a second temperature constant,
wherein the first temperature constant defines a relation between temperature and a voltage of the temperature dependent terminal associated with a particular current, and
wherein the second temperature constant defines a relation between temperature and a difference between a voltage of the temperature dependent terminal associated with the first constant current and a voltage of the temperature dependent terminal associated with the second constant current.

12. The circuit of claim 1, wherein the temperature dependent component comprises a bipolar transistor or a diode.

13. A method of generating a bandgap reference voltage, the method comprising the steps of:
in a first phase of operation, connecting a second terminal of a first capacitor with a temperature dependent terminal of a temperature dependent component, connecting an output terminal of an inverting amplifier with an input terminal of the inverting amplifier, and disconnecting a second terminal of a first capacitor with the output terminal of the inverting amplifier, and applying a first current to the temperature dependent component; and
in a second phase of operation, disconnecting the second terminal of the first capacitor from the temperature dependent terminal of the temperature dependent component, disconnecting the output terminal of the inverting amplifier from the input terminal of the inverting amplifier, and connecting the second terminal of the first capacitor with the output terminal of the inverting amplifier, and applying a second current, which is different from the first current, to the temperature dependent component.

14. A method of generating a bandgap reference voltage comprising the steps of:
providing a first capacitor and a second capacitor;
providing an inverting amplifier associated with an offset voltage, the inverting amplifier having an input terminal connected to a first terminal of the first capacitor and a first terminal of the second capacitor, and an output terminal connected to an output terminal of the bandgap circuit;
providing a temperature dependent component with a temperature dependent terminal wherein a voltage of the temperature dependent terminal has a linear relationship with a temperature based on a temperature constant, wherein the temperature constant depends on an amount of current, wherein a second terminal of the second capacitor is connected to the temperature dependent terminal;
providing a first switch to selectively connect a second terminal of the first capacitor with the temperature dependent terminal;
providing a second switch to selectively connect the output terminal of the inverting amplifier with the input terminal of the inverting amplifier; and
providing a third switch to selectively connect the second terminal of the first capacitor with the output terminal of the inverting amplifier.

15. The method of claim 14, wherein the inverting amplifier is a single-ended amplifier.

16. The method of claim 14, wherein the inverting amplifier is a common source amplifier or an inverter.

17. The method of claim 14, wherein the inverting amplifier comprises a differential amplifier with a differential input comprising an inverting input terminal and a non-inverting input terminal, wherein the non-inverting input terminal is connected to a constant voltage source and the inverting input terminal is the input terminal of the inverting amplifier that is connected to the first terminal of the first capacitor and the first terminal of the second capacitor.

18. The method of claim 14, wherein during a first phase of operation, the first switch is to be closed, the second switch is to be closed, and the third switch is to be open.

19. The method of claim 18, wherein during a second phase of operation following the first phase of operation, the first switch is to be open, the second switch is to be open, and the third switch is to be closed.

20. The method of claim 19, wherein the second switch is to be opened before the first switch is opened near the end of the first phase.

21. The method of claim 19, wherein the first phase and the second phase are non-overlapping in time, and the third switch is to be closed near the beginning of the second phase of operation, after the first switch and the second switch have been opened.

22. The method of claim 19, comprising a current source to apply a constant current to the temperature dependent component, wherein the current source applies a first constant current to the temperature dependent component during the first phase, and apply a second constant current to the temperature dependent component during the second phase, wherein the first constant current is different from the second constant current.

23. The method of claim 22, wherein the first constant current is greater than the second constant current.

24. The method of claim 22, wherein a ratio of a capacitance of the first capacitor to a capacitance of the second capacitor is based on a ratio of a first temperature constant and a second temperature constant,
wherein the first temperature constant defines a relation between temperature and a voltage of the temperature dependent terminal associated with a particular current, and
wherein the second temperature constant defines a relation between temperature and a difference between a voltage of the temperature dependent terminal associated with the first constant current and a voltage of the temperature dependent terminal associated with the second constant current.

25. The method of claim 14, wherein the temperature dependent component comprises a bipolar transistor or a diode.
